(19) United States
(12) Patent Application Publication
(10) Pub. No.: US 2020/0050758 A1
(43) Pub. Date: Feb. 13, 2020

(54) Systems and Methods for Detecting Spam

(71) Applicant: Facebook, Inc., Menlo Park, CA (US)

(72) Inventors: Isaac Rollins Fullinwider, San Francisco, CA (US); Hüseyin Kerem Cevahir, London (GB)

(21) Appl. No.: 15/584,883

(22) Filed: May 2, 2017

(51) Int. Cl. G06F 21/55; G06F 17/30; H04L 12/58; H04L 29/06; G06Q 30/02; G06Q 50/00; H04L 29/08

(52) U.S. Cl. CPC G06F 21/552; G06F 17/30702; G06F 17/30035; H04L 67/025; H04L 63/1441; G06Q 30/0248; G06Q 50/01; H04L 51/12

(57) ABSTRACT

In one embodiment, a method includes a social-networking system receiving requests from client devices of a plurality of users to perform user actions. The system may determine that a first user action of the user actions performed by a first user of the plurality of users is undesirable. The system may access user information associated with the first user and action information associated with the first user action. A first signature associated with the first user may be generated based on the user information and the action information. The system may compare the first signature with signatures associated with user actions performed on the social-networking system to identify a set of matching user actions. The set of matching user actions may be labeled as being undesirable. A machine-learning model may be trained using information associated with the set of matching user actions.

### TECHNICAL FIELD

This disclosure generally relates to systems and methods for detecting undesired online activities, such as spam.

### BACKGROUND

“Spam” is a general term used to refer to unwanted or unsolicited electronic messages, such as advertisements. Spam messages could be distributed as conventional e-mails, text messages, instant messages, blogs, and other types of communication medium. Increasingly, spam is being distributed through social-networking systems. The social-networking platform provides a variety of channels for spam to be distributed. For example, a spammer may distribute spam messages by posting messages, commenting on others' posts, sending instant messages, among others.

A social-networking system, which may include a social-networking website, may enable its users (such as persons or organizations) to interact with it and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more network content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments described herein relates to systems and methods for identifying spam, and using the identified spam as data to refine a spam-detection system. One challenge in designing a spam-detection system is the lack of spam data on which to train or configure the spam-detection system. Particular embodiments described herein may be used to automate the process of flagging potential spam messages in an efficient manner so that sufficient spam data may be available for any down-stream processing, such as a spam-detection system, filtration system, remediation system, reporting system, and any other anti-spam measures. At a high level, individual spam messages may be detected using a relatively more expensive process (e.g., in terms of processing time, labor, cost, etc.). Signatures for those spam messages may be generated using information associated with the spam messages and/or the users who sent the spam messages (the spammers). Using the signatures, additional potential spam messages may be detected quickly and cost-effectively using an automated process to compare the known spam signatures and signatures of the unknown messages. The collection of spam data may then be used to, e.g., train a machine-learning model to automatically detect spam.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example method for detecting spam.

FIG. 2 illustrates an example network environment associated with a social-networking system.

FIG. 3 illustrates an example social graph.

FIG. 4 illustrates an example computer system.

### DESCRIPTION OF EXAMPLE EMBODIMENTS

The embodiments disclosed herein pertain to systems and methods for detecting and combating spam. One challenge of combating spam is that spammers, who can be considered as adversaries to a spam-detection system, may constantly adapt to and circumvent spam-filtering processes. For example, a spammer might circumvent content-based filtering processes (e.g., filtering based on particular messages appearing in spam) by simply changing the content. Thus, one goal of combating spam is to design a sustainable spam-filtering process that is capable of adapting to constantly-changing spam attacks.

Particular embodiments disclosed herein provide systems and methods for gathering information relating to spam. This information in turn may be used to detect and/or react to spam, even as they evolve, since the information will also evolve. Spam-detection systems capable of automatically detecting spam may need sufficient spam data in order to learn what features to look for. Therefore, the quality and quantity of spam data may have a direct impact on the effectiveness of the spam-detection system. Further, since spammers constantly evolve, the speed at which the underlying spam data is generated also affects the effectiveness of the spam-detection system.

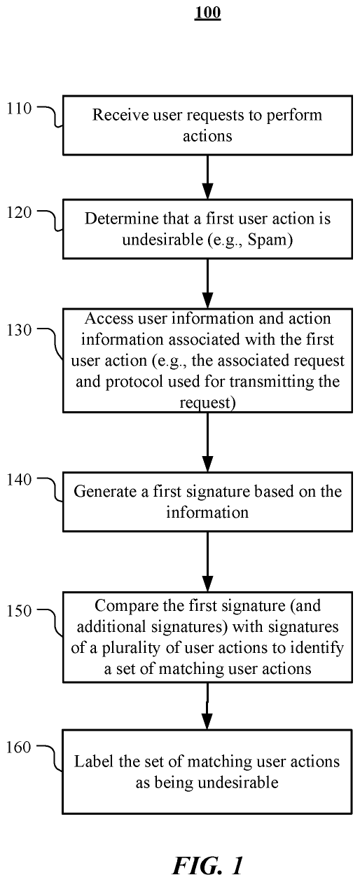

FIG. 1 illustrates an example method 100 for detecting spam. The method may begin at step 110, where a spam-detection system (e.g., of a social-networking system or any other online forum where spammers may target) may receive requests from client devices of a plurality of users to perform user actions on the system. For instance, users may request to perform actions such as, e.g., registration, login, posting comments, sending friend requests, or any other action that may be performed through the system. While some of these actions may not directly involve sending content to spam victims or recipients, they may nevertheless be part of the spamming process. For example, a spammer may register a fake account, login to a compromised account as an imposter, and/or try to befriend spam victims, and then subsequently send out spam messages to connected users. The system may monitor a variety of such user actions to identify potential spam attacks.

At step 120, the system in particular embodiments may determine that a first user action performed by a first user of the plurality of users may be undesirable. The undesirable action may be, for example, publication of spam or offensive content, an abuse of the system's features, a violation of system policies (e.g., registering fake or multiple accounts), or any other action or content that the system wishes to prevent. In particular embodiments, the system may provide its users with user interface features allowing them to report potentially undesirable actions. For example, the system may present content posted on a social-networking system, user profiles, relationships, affinity indications, and any other user-generated information with a user-interface option (e.g., a button or menu option, which may be hidden unless activated) that may be used to report the associated information as being potentially undesirable. In particular embodiments, the system may automatically monitor activities to identify those that are potential undesirable. For example, the system may perform content-based checks to determine whether content associated with an action is spam (e.g., by looking for keywords, images, and/or links related to sales, promotions, offers, etc.). In particular embodiments, a user-reported activity may be reported to the system and flagged for further review.

In particular embodiments, potential undesirable action (e.g., spam) flagged by the discovery process described above (e.g., either through user reporting or automated detection) may be reviewed or further analyzed to verify whether they are actually or sufficiently likely to be undesirable (e.g., associated with a spam attack). This process may be performed manually or automatically via additional tests. For example, system operators may manually review each of the flagged actions to determine whether it is likely associated with an undesirable action. As another example, the system may further process data associated with the action to determine how likely the action is indeed undesirable. For example, the activity pattern of a user may be indicative of a likelihood of the user being a spammer. Since spamming activities may be controlled by bots (e.g., computer software or scripts), such activities may exhibit activity patterns different from that of regular users. For instance, a regular user may engage in online activities during typical waking hours our non-working hours. Bots, on the other hand, are not similarly constrained and therefore may not have a similar behavior pattern (e.g., bots may be active throughout the day). Thus, in particular embodiments, the system may compare behavior patterns of users to automatically assess the likelihood of them being spammers.

In particular embodiments, the system may refrain from taking immediate remediation action to remove the undesirable actions or confront the actors upon detection at this stage (e.g., determinations made at step 120). In particular embodiments, despite determining that a user's action is undesirable, the system may choose not to immediately inform the user of the determination prior to utilization of the data (e.g., to train a machine-learning model). As discussed above, spam data, for example, may be scarce yet valuable for purposes of improving a spam-detection system. By not taking immediate remediation action, the undesirable activities may continue, thereby generating more data for improving the system. Further, not taking immediate action may obfuscate how the system is detecting spam since no immediate feedback is provided to spammers, which in turn may make it more difficult for them to respond to and circumvent the spam-detection system.

The system in particular embodiments may use each undesirable action determined in step 120 to generate a signature of the actor, which in turn may be used to automatically identify additional undesirable actions with increased precision. Having an automated system for identifying spam with improved precision may minimize the relatively more expensive process of manually reviewing and identifying spam. As previously discussed with reference to step 120, the system may determine that a first user action performed by a first user may be undesirable. Then at step 130, the system in particular embodiments may access user information associated with that first user and action information associated with the first user action. User information may include, for example, the user's profile information, name, email address, phone number, demographics, country of origin, social-graph data, relationships within the social-networking system, history or pattern of other actions performed on the social-networking system, computing device information, and any other information associated with the user. Action information may include, for example, information associated with: the request for performing the first user action and a network communication protocol used for transmitting that request. Action information may also include, e.g., an identification of the action that was performed (e.g., registering a new account, logging into an existing account, posting a message, commenting on a post, liking a post, sharing a link, etc.). The system may have obtained and stored such information by, e.g., soliciting the information from the user, monitoring and tracking user activities on the system, automatically determining certain information based on network communications with the user (e.g., the network protocol used), and by any other suitable means.

At step 140, the system in particular embodiments may generate a first signature associated with the first user based on the information associated with the first user and the action information associated with the first user action. In particular embodiments, the system may generate a signature for each identified undesirable action (from step 120), and register the signature in the system (e.g., storing them in a database). In particular embodiments, a signature may include various features of the corresponding action and user. For example, a signature may include features that relate to the spammer himself (e.g., country of origin, computer system used, operating system used, IP address, whether the user's email address includes strange patterns that suggest a fake or unused email address, social-graph data, activity pattern, etc.). In particular embodiments, a signature may also or alternatively include features that relate to the action performed, such as, e.g., the type of action performed (e.g., registration, login, friend request, posting content, or any other action that a user may perform through the system), a representation of the network communication and/or encryption protocol that the user used to request the system to perform the action, metadata relating to the HTTP request, the timestamp of the action, and any other information associated with the action. In particular embodiments, as signature does not include content feature associated with the offending content. In particular embodiments, a signature may be generated based on a function that takes as input the feature values of interest. For example, the signature function may be a hash function. In particular embodiments, the signature may also be defined as a listing of the feature values.

Using the registered signatures, the system may then automatically identify additional undesirable user actions (e.g., spam). For example, after generating the first signature (e.g., step 140), the system at step 150 may, in particular embodiments, compare the first signature with signatures associated with a plurality of user actions performed on the social-networking system to identify a set of matching user actions selected from the plurality of user actions. For example, as new actions are performed on the social-networking system, the system may generate a signature for each new action and compare it with the registered signatures of the previously-identified undesirable actions. At step 160, a new action's signature that sufficiently matches a registered signature may be automatically labeled as being undesirable. The registered signatures thus enable the system to efficiently identify user actions that are likely to be undesirable with sufficient precision to be useful in a variety of automated processes.

In particular embodiments, the set of matching user actions may be used as labeled training data for a supervised machine-learning model configured to predict whether a given user action is undesirable. The system may train a machine-learning model using information associated with the set of matching user actions. For example, spam data identified using the registered spam signatures may be treated as a labeled training data set for supervised machine learning algorithms. Examples of machine-learning models include neural networks, decision trees, regression analysis of linear combination of weighted features, and any other suitable machine-learning models. In particular embodiments, the machine-learning model may include one or more features used to generate the signatures (e.g., country of original, HTTP metadata, communication protocol information, and other information associated with user and/or action), as well as content features of content associated with the action (e.g., a measure of predetermined keywords or symbols found in the content, a vector representation of the content, whether the content includes links to unverified hosts, whether the content includes advertisements, etc.). Because the signature comparison process is relatively cheap, the training data may be gathered on-the-fly as new actions are being requested. This in turn means that the training data could reflect the current state of the undesirable actions (e.g., the current version of a spam attack). The quantity and quality of the training data enable the system to train an improved machine-learning model for detecting the current state of the undesirable activities. This is a feature that is particularly useful for detecting undesirable activities that are constantly changing, such as spam.

The registry of signatures of undesirable actions may improve a variety of systems designed for detecting and/or remedying undesirable actions. In particular embodiments, the signatures may help a system track/monitor undesirable actions and gather valuable data. For example, gathering information about an undesirable action, such as a spam attack, may be more valuable than temporarily stopping the detected actions since the information gathered may be used at a more global level for detecting such actions. For example, when undesirable actions are detected using the signature, the system may refrain from taking any immediate action and instead monitor additional actions associated with the detected undesirable actions. As an example, once the system determines that a user's action is likely undesirable, the system may monitor the user's other actions to gather additional information. For instance, once the system determines that a user's post is likely spam, the system may monitor the user's registration, login, friend requests, and any other actions through the system. As another example, the system may monitor other users' responses to the undesirable actions. For instance, if the undesirable action is the posting of spam, the system may monitor how effective that spam is by monitoring how other users interact with the posted spam (e.g., in terms of how many other users read, clicked, or engaged the spam message). Information that may be monitored includes posting activity, consumption or engagement statistics of any posted spam, etc. This information may be used for analytics or by other downstream processes, such as training a machine-learning model, as described above.

In particular embodiments, the registered signatures of undesirable actions may be used to automate report generation. For example, the system may receive a new request to perform a new user action on the social-networking system. The system may determine that the new user action may be undesirable (e.g., using the process described with reference to step 120 of FIG. 1) and generate a signature associated with the new user action. The system may then compare the generated signature with the registered signatures of undesirable actions. Then based on a determination that a match is found, the system may report the new user action as being undesirable. In particular embodiments, the new user action may be automatically reported without requiring further human investigation or verification.

In particular embodiments, undesirable actions that has been reported or detected using the trained machine-learning model as described above may trigger automatic remediation. Examples of remediation may include: deleting or removing the associated content so that the content is no longer published or available on the social-networking system; requesting a user associated with an undesirable action to change his/her password for the system (e.g., the user's account may have been hacked); or requesting the user associated with the undesirable action to respond to an authentication question or other forms of authentication challenges. In particular embodiments, the remediation may be performed at random times or based on any other timing scheme (e.g., remediation may occur at certain fixed times and/or days of the week) that would obfuscate the exact moment at which spam is discovered to minimize feedback for the spammers. In particular embodiments, remediation may be prioritized based on monitored data. For example, remediation may be prioritized for spam with a high consumption/engagement rate (e.g., rate at which the spam is viewed or responded to by other users) to minimize the impact of the spam.

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates an example method for detecting undesirable actions (e.g., spam) including the particular steps of the method of FIG. 1, this disclosure contemplates any suitable method for detecting undesirable actions including any suitable steps, which may include all, some, or none of the steps of the method of FIG. 1, where appropriate. Furthermore, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

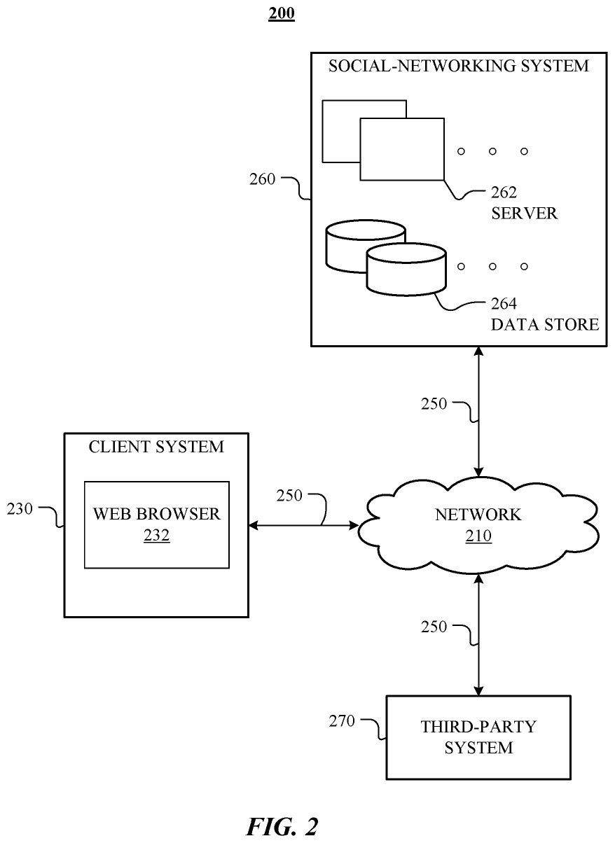

FIG. 2 illustrates an example network environment 200 associated with a social-networking system. Network environment 200 includes a client system 230, a social-networking system 260, and a third-party system 270 connected to each other by a network 210. Although FIG. 2 illustrates a particular arrangement of client system 230, social-networking system 260, third-party system 270, and network 210, this disclosure contemplates any suitable arrangement of client system 230, social-networking system 260, third-party system 270, and network 210. As an example and not by way of limitation, two or more of client system 230, social-networking system 260, and third-party system 270 may be connected to each other directly, bypassing network 210. As another example, two or more of client system 230, social-networking system 260, and third-party system 270 may be physically or logically co-located with each other in whole or in part. Moreover, although FIG. 2 illustrates a particular number of client systems 230, social-networking systems 260, third-party systems 270, and networks 210, this disclosure contemplates any suitable number of client systems 230, social-networking systems 260, third-party systems 270, and networks 210. As an example and not by way of limitation, network environment 200 may include multiple client system 230, social-networking systems 260, third-party systems 270, and networks 210.

This disclosure contemplates any suitable network 210. As an example and not by way of limitation, one or more portions of network 210 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 210 may include one or more networks 210.

Links 250 may connect client system 230, social-networking system 260, and third-party system 270 to communication network 210 or to each other. This disclosure contemplates any suitable links 250. In particular embodiments, one or more links 250 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 250 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 250, or a combination of two or more such links 250. Links 250 need not necessarily be the same throughout network environment 200. One or more first links 250 may differ in one or more respects from one or more second links 250.

In particular embodiments, client system 230 may be an electronic device including hardware, software, or embedded logic components or a combination of two or more such components and capable of carrying out the appropriate functionalities implemented or supported by client system 230. As an example and not by way of limitation, a client system 230 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 230. A client system 230 may enable a network user at client system 230 to access network 210. A client system 230 may enable its user to communicate with other users at other client systems 230.

In particular embodiments, client system 230 may include a web browser 232, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 230 may enter a Uniform Resource Locator (URL) or other address directing the web browser 232 to a particular server (such as server 262, or a server associated with a third-party system 270), and the web browser 232 may generate a Hyper Text Transfer Protocol (HTTP) request and communicate the HTTP request to server. The server may accept the HTTP request and communicate to client system 230 one or more Hyper Text Markup Language (HTML) files responsive to the HTTP request. Client system 230 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 260 may be a network-addressable computing system that can host an online social network. Social-networking system 260 may generate, store, receive, and send social-networking data, such as, for example, user-profile data, concept-profile data, social-graph information, or other suitable data related to the online social network. Social-networking system 260 may be accessed by the other components of network environment 200 either directly or via network 210. As an example and not by way of limitation, client system 230 may access social-networking system 260 using a web browser 232, or a native application associated with social-networking system 260 (e.g., a mobile social-networking application, a messaging application, another suitable application, or any combination thereof) either directly or via network 210. In particular embodiments, social-networking system 260 may include one or more servers 262. Each server 262 may be a unitary server or a distributed server spanning multiple computers or multiple datacenters. Servers 262 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 262 may include hardware, software, or embedded logic components or a combination of two or more such components for carrying out the appropriate functionalities implemented or supported by server 262. In particular embodiments, social-networking system 260 may include one or more data stores 264. Data stores 264 may be used to store various types of information. In particular embodiments, the information stored in data stores 264 may be organized according to specific data structures. In particular embodiments, each data store 264 may be a relational, columnar, correlation, or other suitable database. Although this disclosure describes or illustrates particular types of databases, this disclosure contemplates any suitable types of databases. Particular embodiments may provide interfaces that enable a client system 230, a social-networking system 260, or a third-party system 270 to manage, retrieve, modify, add, or delete, the information stored in data store 264.

In particular embodiments, social-networking system 260 may store one or more social graphs in one or more data stores 264. In particular embodiments, a social graph may include multiple nodes—which may include multiple user nodes (each corresponding to a particular user) or multiple concept nodes (each corresponding to a particular concept)—and multiple edges connecting the nodes. Social-networking system 260 may provide users of the online social network the ability to communicate and interact with other users. In particular embodiments, users may join the online social network via social-networking system 260 and then add connections (e.g., relationships) to a number of other users of social-networking system 260 to whom they want to be connected. Herein, the term “friend” may refer to any other user of social-networking system 260 with whom a user has formed a connection, association, or relationship via social-networking system 260.

In particular embodiments, social-networking system 260 may provide users with the ability to take actions on various types of items or objects, supported by social-networking system 260. As an example and not by way of limitation, the items and objects may include groups or social networks to which users of social-networking system 260 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 260 or by an external system of third-party system 270, which is separate from social-networking system 260 and coupled to social-networking system 260 via a network 210.

In particular embodiments, social-networking system 260 may be capable of linking a variety of entities. As an example and not by way of limitation, social-networking system 260 may enable users to interact with each other as well as receive content from third-party systems 270 or other entities, or to allow users to interact with these entities through an application programming interfaces (API) or other communication channels.

In particular embodiments, a third-party system 270 may include one or more types of servers, one or more data stores, one or more interfaces, including but not limited to APIs, one or more web services, one or more content sources, one or more networks, or any other suitable components, e.g., that servers may communicate with. A third-party system 270 may be operated by a different entity from an entity operating social-networking system 260. In particular embodiments, however, social-networking system 260 and third-party systems 270 may operate in conjunction with each other to provide social-networking services to users of social-networking system 260 or third-party systems 270. In this sense, social-networking system 260 may provide a platform, or backbone, which other systems, such as third-party systems 270, may use to provide social-networking services and functionality to users across the Internet.

In particular embodiments, a third-party system 270 may include a third-party content object provider. A third-party content object provider may include one or more sources of content objects, which may be communicated to a client system 230. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 260 also includes user-generated content objects, which may enhance a user's interactions with social-networking system 260. User-generated content may include anything a user can add, upload, send, or “post” to social-networking system 260. As an example and not by way of limitation, a user communicates posts to social-networking system 260 from a client system 230. Posts may include data such as status updates or other textual data, location information, photos, videos, links, music or other similar data or media. Content may also be added to social-networking system 260 by a third-party through a “communication channel,” such as a newsfeed or stream.

In particular embodiments, social-networking system 260 may include a variety of servers, sub-systems, programs, modules, logs, and data stores. In particular embodiments, social-networking system 260 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 260 may also include suitable components such as network interfaces, security mechanisms, load balancers, failover servers, management-and-network-operations consoles, other suitable components, or any suitable combination thereof. In particular embodiments, social-networking system 260 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 260 to one or more client systems 230 or one or more third-party system 270 via network 210. The web server may include a mail server or other messaging functionality for receiving and routing messages between social-networking system 260 and one or more client systems 230. An API-request server may allow a third-party system 270 to access information from social-networking system 260 by calling one or more APIs. An action logger may be used to receive communications from a web server about a user's actions on or off social-networking system 260. In conjunction with the action log, a third-party-content-object log may be maintained of user exposures to third-party-content objects. A notification controller may provide information regarding content objects to a client system 230. Information may be pushed to a client system 230 as notifications, or information may be pulled from client system 230 responsive to a request received from client system 230. Authorization servers may be used to enforce one or more privacy settings of the users of social-networking system 260. A privacy setting of a user determines how particular information associated with a user can be shared. The authorization server may allow users to opt in to or opt out of having their actions logged by social-networking system 260 or shared with other systems (e.g., third-party system 270), such as, for example, by setting appropriate privacy settings. Third-party-content-object stores may be used to store content objects received from third parties, such as a third-party system 270. Location stores may be used for storing location information received from client systems 230 associated with users. Advertisement-pricing modules may combine social information, the current time, location information, or other suitable information to provide relevant advertisements, in the form of notifications, to a user.

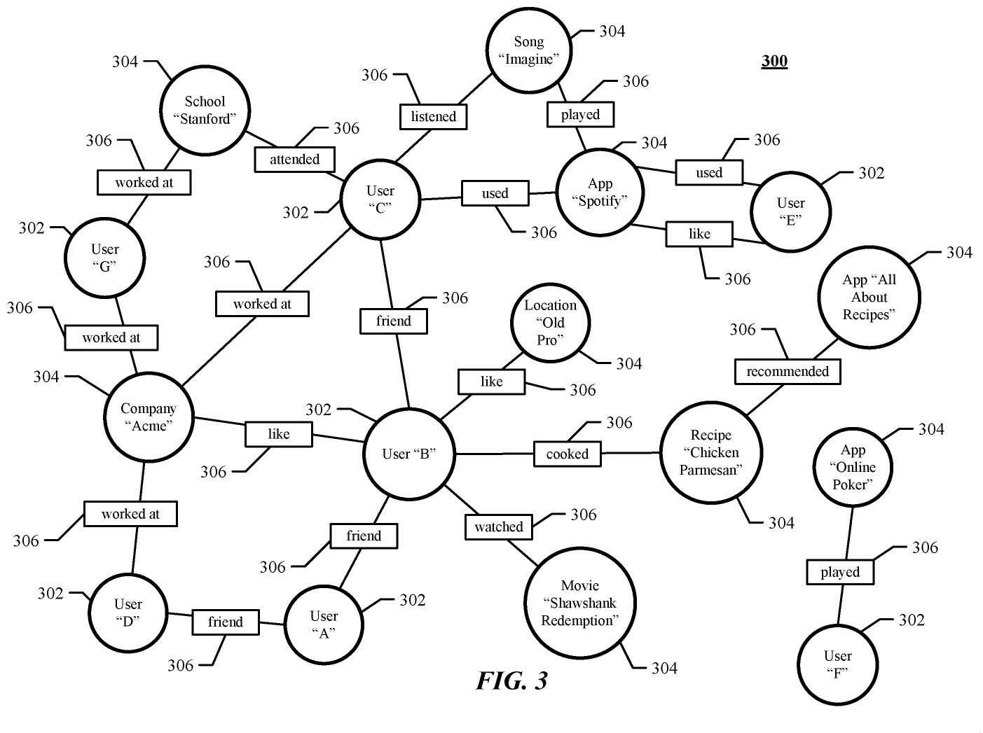

FIG. 3 illustrates example social graph 300. In particular embodiments, social-networking system 260 may store one or more social graphs 300 in one or more data stores. In particular embodiments, social graph 300 may include multiple nodes—which may include multiple user nodes 302 or multiple concept nodes 304—and multiple edges 306 connecting the nodes. Example social graph 300 illustrated in FIG. 3 is shown, for didactic purposes, in a two-dimensional visual map representation. In particular embodiments, a social-networking system 260, client system 230, or third-party system 270 may access social graph 300 and related social-graph information for suitable applications. The nodes and edges of social graph 300 may be stored as data objects, for example, in a data store (such as a social-graph database). Such a data store may include one or more searchable or queryable indexes of nodes or edges of social graph 300.

In particular embodiments, a user node 302 may correspond to a user of social-networking system 260. As an example and not by way of limitation, a user may be an individual (human user), an entity (e.g., an enterprise, business, or third-party application), or a group (e.g., of individuals or entities) that interacts or communicates with or over social-networking system 260. In particular embodiments, when a user registers for an account with social-networking system 260, social-networking system 260 may create a user node 302 corresponding to the user, and store the user node 302 in one or more data stores. Users and user nodes 302 described herein may, where appropriate, refer to registered users and user nodes 302 associated with registered users. In addition or as an alternative, users and user nodes 302 described herein may, where appropriate, refer to users that have not registered with social-networking system 260. In particular embodiments, a user node 302 may be associated with information provided by a user or information gathered by various systems, including social-networking system 260. As an example and not by way of limitation, a user may provide his or her name, profile picture, contact information, birth date, sex, marital status, family status, employment, education background, preferences, interests, or other demographic information. In particular embodiments, a user node 302 may be associated with one or more data objects corresponding to information associated with a user. In particular embodiments, a user node 302 may correspond to one or more webpages.

In particular embodiments, a concept node 304 may correspond to a concept. As an example and not by way of limitation, a concept may correspond to a place (such as, for example, a movie theater, restaurant, landmark, or city); a website (such as, for example, a website associated with social-network system 260 or a third-party website associated with a web-application server); an entity (such as, for example, a person, business, group, sports team, or celebrity); a resource (such as, for example, an audio file, video file, digital photo, text file, structured document, or application) which may be located within social-networking system 260 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 304 may be associated with information of a concept provided by a user or information gathered by various systems, including social-networking system 260. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 304 may be associated with one or more data objects corresponding to information associated with concept node 304. In particular embodiments, a concept node 304 may correspond to one or more webpages.

In particular embodiments, a node in social graph 300 may represent or be represented by a webpage (which may be referred to as a “profile page”). Profile pages may be hosted by or accessible to social-networking system 260. Profile pages may also be hosted on third-party websites associated with a third-party system 270. As an example and not by way of limitation, a profile page corresponding to a particular external webpage may be the particular external webpage and the profile page may correspond to a particular concept node 304. Profile pages may be viewable by all or a selected subset of other users. As an example and not by way of limitation, a user node 302 may have a corresponding user-profile page in which the corresponding user may add content, make declarations, or otherwise express himself or herself. As another example and not by way of limitation, a concept node 304 may have a corresponding concept-profile page in which one or more users may add content, make declarations, or express themselves, particularly in relation to the concept corresponding to concept node 304.

In particular embodiments, a concept node 304 may represent a third-party webpage or resource hosted by a third-party system 270. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 230 to send to social-networking system 260 a message indicating the user's action. In response to the message, social-networking system 260 may create an edge (e.g., a check-in-type edge) between a user node 302 corresponding to the user and a concept node 304 corresponding to the third-party webpage or resource and store edge 306 in one or more data stores.

In particular embodiments, a pair of nodes in social graph 300 may be connected to each other by one or more edges 306. An edge 306 connecting a pair of nodes may represent a relationship between the pair of nodes. In particular embodiments, an edge 306 may include or represent one or more data objects or attributes corresponding to the relationship between a pair of nodes. As an example and not by way of limitation, a first user may indicate that a second user is a “friend” of the first user. In response to this indication, social-networking system 260 may send a “friend request” to the second user. If the second user confirms the “friend request,” social-networking system 260 may create an edge 306 connecting the first user's user node 302 to the second user's user node 302 in social graph 300 and store edge 306 as social-graph information in one or more of data stores 264. In the example of FIG. 3, social graph 300 includes an edge 306 indicating a friend relation between user nodes 302 of user “A” and user “B” and an edge indicating a friend relation between user nodes 302 of user “C” and user “B.” Although this disclosure describes or illustrates particular edges 306 with particular attributes connecting particular user nodes 302, this disclosure contemplates any suitable edges 306 with any suitable attributes connecting user nodes 302. As an example and not by way of limitation, an edge 306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 300 by one or more edges 306.

In particular embodiments, an edge 306 between a user node 302 and a concept node 304 may represent a particular action or activity performed by a user associated with user node 302 toward a concept associated with a concept node 304. As an example and not by way of limitation, as illustrated in FIG. 3, a user may “like,” “attended,” “played,” “listened,” “cooked,” “worked at,” or “watched” a concept, each of which may correspond to an edge type or subtype. A concept-profile page corresponding to a concept node 304 may include, for example, a selectable “check in” icon (such as, for example, a clickable “check in” icon) or a selectable “add to favorites” icon. Similarly, after a user clicks these icons, social-networking system 260 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 260 may create a “listened” edge 306 and a “used” edge (as illustrated in FIG. 3) between user nodes 302 corresponding to the user and concept nodes 304 corresponding to the song and application to indicate that the user listened to the song and used the application. Moreover, social-networking system 260 may create a “played” edge 306 (as illustrated in FIG. 3) between concept nodes 304 corresponding to the song and the application to indicate that the particular song was played by the particular application. In this case, “played” edge 306 corresponds to an action performed by an external application (SPOTIFY) on an external audio file (the song “Imagine”). Although this disclosure describes particular edges 306 with particular attributes connecting user nodes 302 and concept nodes 304, this disclosure contemplates any suitable edges 306 with any suitable attributes connecting user nodes 302 and concept nodes 304. Moreover, although this disclosure describes edges between a user node 302 and a concept node 304 representing a single relationship, this disclosure contemplates edges between a user node 302 and a concept node 304 representing one or more relationships. As an example and not by way of limitation, an edge 306 may represent both that a user likes and has used at a particular concept. Alternatively, another edge 306 may represent each type of relationship (or multiples of a single relationship) between a user node 302 and a concept node 304 (as illustrated in FIG. 3 between user node 302 for user “E” and concept node 304 for “SPOTIFY”).

In particular embodiments, social-networking system 260 may create an edge 306 between a user node 302 and a concept node 304 in social graph 300. As an example and not by way of limitation, a user viewing a concept-profile page (such as, for example, by using a web browser or a special-purpose application hosted by the user's client system 230) may indicate that he or she likes the concept represented by the concept node 304 by clicking or selecting a “Like” icon, which may cause the user's client system 230 to send to social-networking system 260 a message indicating the user's liking of the concept associated with the concept-profile page. In response to the message, social-networking system 260 may create an edge 306 between user node 302 associated with the user and concept node 304, as illustrated by “like” edge 306 between the user and concept node 304. In particular embodiments, social-networking system 260 may store an edge 306 in one or more data stores. In particular embodiments, an edge 306 may be automatically formed by social-networking system 260 in response to a particular user action. As an example and not by way of limitation, if a first user uploads a picture, watches a movie, or listens to a song, an edge 306 may be formed between user node 302 corresponding to the first user and concept nodes 304 corresponding to those concepts. Although this disclosure describes forming particular edges 306 in particular manners, this disclosure contemplates forming any suitable edges 306 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 260). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 260 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 260) or RSVP (e.g., through social-networking system 260) to an event associated with the advertisement. In addition or as an alternative, an advertisement may include social-networking-system content directed to the user. As an example and not by way of limitation, an advertisement may display information about a friend of the user within social-networking system 260 who has taken an action associated with the subject matter of the advertisement.

In particular embodiments, social-networking system 260 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 270 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 260 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 260 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 260 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 260 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 260 may calculate a coefficient based on a user's actions. Social-networking system 260 may monitor such actions on the online social network, on a third-party system 270, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 260 may calculate a coefficient based on the user's actions with particular types of content. The content may be associated with the online social network, a third-party system 270, or another suitable system. The content may include users, profile pages, posts, news stories, headlines, instant messages, chat room conversations, emails, advertisements, pictures, video, music, other suitable objects, or any combination thereof. Social-networking system 260 may analyze a user's actions to determine whether one or more of the actions indicate an affinity for subject matter, content, other users, and so forth. As an example and not by way of limitation, if a user frequently posts content related to “coffee” or variants thereof, social-networking system 260 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 260 may calculate a coefficient based on the type of relationship between particular objects. Referencing the social graph 300, social-networking system 260 may analyze the number and/or type of edges 306 connecting particular user nodes 302 and concept nodes 304 when calculating a coefficient. As an example and not by way of limitation, user nodes 302 that are connected by a spouse-type edge (representing that the two users are married) may be assigned a higher coefficient than a user nodes 302 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 260 may determine that the user has a higher coefficient with respect to the first photo than the second photo because having a tagged-in-type relationship with content may be assigned a higher weight and/or rating than having a like-type relationship with content. In particular embodiments, social-networking system 260 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 260 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 300. As an example and not by way of limitation, social-graph entities that are closer in the social graph 300 (i.e., fewer degrees of separation) may have a higher coefficient than entities that are further apart in the social graph 300.

In particular embodiments, social-networking system 260 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 230 of the user). A first user may be more interested in other users or concepts that are closer to the first user. As an example and not by way of limitation, if a user is one mile from an airport and two miles from a gas station, social-networking system 260 may determine that the user has a higher coefficient for the airport than the gas station based on the proximity of the airport to the user.

In particular embodiments, social-networking system 260 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 260 may provide information that is relevant to user's interests and current circumstances, increasing the likelihood that they will find such information of interest. In particular embodiments, social-networking system 260 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 260 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 260 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 270 (e.g., via an API or other communication channel), or from another suitable system. In response to the request, social-networking system 260 may calculate the coefficient (or access the coefficient information if it has previously been calculated and stored). In particular embodiments, social-networking system 260 may measure an affinity with respect to a particular process. Different processes (both internal and external to the online social network) may request a coefficient for a particular object or set of objects. Social-networking system 260 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

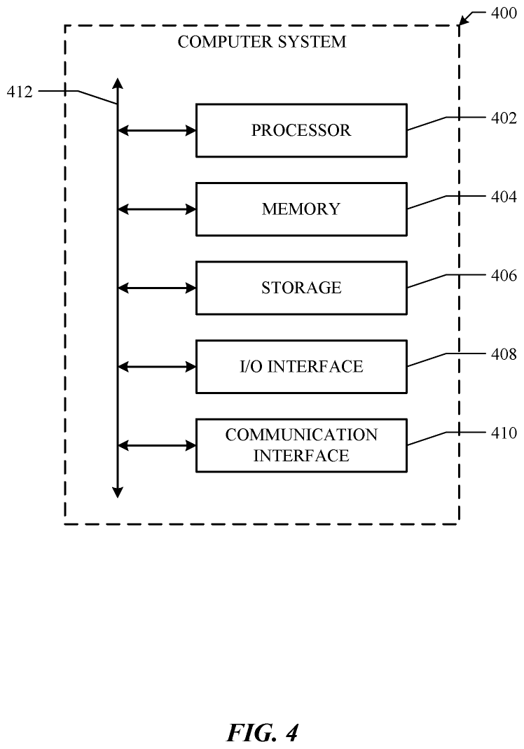

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The claims:

1. A method, comprising:
by a computing system, receiving requests from client devices of a plurality of users to perform user actions;
by the computing system, determining that a first user action of the user actions performed by a first user of the plurality of users is undesirable;
by the computing system, accessing user information associated with the first user and action information associated with the first user action, the action information comprising information associated with:
the request for performing the first user action;
a network communication protocol used for transmitting that request; and
one or more timestamps associated to the user action denoting a time over which the user action occurred;
by the computing system, generating a first signature associated with the first user based on the information associated with the first user and the action information associated with the first user action;
by the computing system, comparing the first signature with signatures associated with a plurality of user actions performed by other users to identify a set of matching user actions selected from the plurality of user actions, wherein the plurality of other user actions occur after the time of the signature of the first user action; and
by the computing system, labeling the set of matching user actions as being undesirable.

2. The method of claim 1, wherein the action information associated with the first user action comprises information associated with other user actions performed by the first user.

3. The method of claim 1, wherein the determining that the first user action is undesirable is based on activity patterns of the first user.

4. The method of claim 1, wherein the information associated with the first user comprises: a country from which the first user transmitted the request for the first user action, system information of the client device used by the first user, or network address of the client device.

5. The method of claim 1, wherein the information associated with the request for performing the first user action comprises metadata associated with an HTTP request.

6. The method of claim 1, wherein the network communication protocol comprises an encryption protocol.

7. The method of claim 1, further comprising:
after a time period since the determination that the first user action is undesirable, performing remediation action associated with the first user;
wherein the time period is determined based on a predetermined timing scheme.

8. The method of claim 1, further comprising:
by the computing system, monitoring additional actions associated with the set of matching user actions.

9. The method of claim 8, wherein the additional actions comprise an additional action performed by a user who performed one of the matching user actions.

10. The method of claim 8, wherein the additional actions comprise an action performed in response to one of the matching user actions.

11. The method of claim 1, further comprising:
by the computing system, receiving a second request to perform a second user action;
by the computing system, determining that the second user action is undesirable;
by the computing system, generating a second signature associated with the second user action;
by the computing system, determining that the second signature matches the first signature; and
by the computing system, based on the determination that the second user action is undesirable and the determination that the second signature matches the first signature, reporting the second user action as being undesirable.

12. The method of claim 1, further comprising:
by the computing system, receiving a second request to perform a second user action;
by the computing system, determining that the second user action is undesirable;
by the computing system, generating a second signature associated with the second user action;
by the computing system, determining that the second signature matches the first signature; and
by the computing system, based on the determination that the second user action is undesirable and the determination that the second signature matches the first signature, performing one or more remediation actions.

13. The method of claim 12, wherein the one or more remediation actions comprise: removing content associated with the second user action from being published, requesting a second user associated with the second user action to change a password, or requesting the second user associated with the second user action to respond to an authentication question.

14. The method of claim 12, further comprising:
by the computing system, determining a rate at which content associated with the second user action is viewed or responded to by other users;
wherein the performing of the one or more remediation actions is prioritized against other remediation actions based on the determined rate.

15. The method of claim 1, further comprising:
by the computing system, training a machine-learning model using information associated with the set of matching user actions, wherein the machine-learning model is trained to predict whether a given user action is undesirable.

16. One or more computer-readable non-transitory storage media comprising software that is operable when executed by a computer system to:
receive requests from client devices of a plurality of users to perform user actions;
determine that a first user action of the user actions performed by a first user of the plurality of users is undesirable;
access user information associated with the first user and action information associated with the first user action, the action information comprising information associated with:
the request for performing the first user action;
a network communication protocol used for transmitting that request; and
one or more timestamps associated to the user action denoting a time over which the user action occurred;
generate a first signature associated with the first user based on the information associated with the first user and the action information associated with the first user action;
compare the first signature with signatures associated with a plurality of user actions performed by other users to identify a set of matching user actions selected from the plurality of user actions, wherein the plurality of other user actions occur after the time of the signature of the first user action; and
label the set of matching user actions as being undesirable.

17. The media of claim 16, wherein the information associated with the request for performing the first user action comprises metadata associated with an HTTP request.

18. The media of claim 16, wherein the network communication protocol comprises an encryption protocol.

19. A system comprising:
one or more processors; and
one or more computer-readable non-transitory storage media coupled to one or more of the processors and comprising instructions operable when executed by one or more of the processors to cause the system to:
receive requests from client devices of a plurality of users to perform user actions;
determine that a first user action of the user actions performed by a first user of the plurality of users is undesirable;
access user information associated with the first user and action information associated with the first user action, the action information comprising information associated with:
the request for performing the first user action;
a network communication protocol used for transmitting that request; and
one or more timestamps associated to the user action denoting a time over which the user action occurred;
generate a first signature associated with the first user based on the information associated with the first user and the action information associated with the first user action;
compare the first signature with signatures associated with a plurality of user actions performed by other users to identify a set of matching user actions selected from the plurality of user actions, wherein the plurality of other user actions occur after the time of the signature of the first user action; and
label the set of matching user actions as being undesirable.

20. The system of claim 19, wherein the information associated with the request for performing the first user action comprises metadata associated with an HTTP request.
